(19) United States
(12) Patent Application Publication
(10) Pub. No.: US 2019/0277657 A1
(43) Pub. Date: Sep. 12, 2019

(54) STATIC STATE DETERMINING METHOD AND APPARATUS

(71) Applicant: HUAWEI TECHNOLOGIES CO., LTD., Shenzhen (CN)

(72) Inventors: Quan ZHANG, Wuhan (CN); XiaoJi NIU, Wuhan (CN); Liding FU, Beijing (CN)

(21) Appl. No.: 16/424,190

(22) Filed: May 28, 2019

Related U.S. Application Data
(63) Continuation of application No. PCT/CN2017/092650, filed on Jul. 12, 2017.

(30) Foreign Application Priority Data
Nov. 29, 2016 (CN) 201611088239.4

(51) Int. Cl. G01C 25/00; G01C 21/16; G01C 21/20

(52) U.S. Cl. CPC G01C 25/005; G01C 21/20; G01C 21/165

(57) ABSTRACT

A static state determining method and apparatus are disclosed to resolve a problem in the prior art that accuracy of determining a static state is low. An inertial navigation system obtains a first running data that is measured by an IMU in a first specified duration, determines N first standard deviations of the first running data; matches the N first standard deviations with a prestored database; determines, in the prestored database, a piece of first information corresponding to each of the N second standard deviations; multiplies a first probability in each of the N pieces of first information by a corresponding weight, and adds N values obtained through the multiplication and if the second probability is greater than or equal to a static probability threshold, the inertial navigation system determines that a device in which the inertial navigation system is located is in a static state in the first specified duration.

### CROSS-REFERENCE TO RELATED APPLICATIONS

This application is a continuation of International Application No. PCT/CN2017092650, filed on Jul. 12, 2017, which claims priority to Chinese Patent Application No. 201611088239.4, filed on Nov. 29, 2016, The disclosures of the aforementioned applications are herein incorporated by reference in their entireties.

### TECHNICAL FIELD

Embodiments of the application relate to the field of inertial navigation technologies, and in particular, to a static state determining method and apparatus.

### BACKGROUND

With maturity and development of micro-electro-mechanical systems (MEMS) technologies, inertial navigation technologies have a rapidly increasing application range, and currently, are widely applied to vehicle navigation and pedestrian navigation. An inertial navigation system (INS) is a dead reckoning system, and includes an inertial measurement unit (IMU) and an inertial navigation mechanization algorithm. However, due to a sensor error in the INS, an INS error becomes larger as time increases. To resolve the problem that the INS error becomes larger as the time increases, a zero velocity update (ZUPT) means is used as a currently used solution to reduce the INS error.

Zero velocity update, or referred to as ZUPT detection, is to determine a time period in which a carrier is in a static state, based on data measured by the IMU. A zero velocity update detection method in the prior art is a threshold method. Appropriate thresholds are preset for collected data measured by the IMU, when the INS is in a moving state and when the INS is in a static state. In a process of using the INS, the data measured by the IMU or new data that is obtained through projection transformation performed on the data is compared with the thresholds. When the data measured by the IMU or the new data is less than or equal to the thresholds, a time period in which the INS is in the static state is determined.

In conclusion, according to the detection method in the prior art, accuracy of determining the static state of the INS is low. How to improve the accuracy of determining the static state of the INS is a problem to be resolved at present.

### SUMMARY

Embodiments of the present invention provide a static state determining method and apparatus, to improve accuracy of determining a static state of a target vehicle, a device, or an apparatus.

According to a first aspect, an embodiment of the present invention provides a static state determining method, including: obtaining, by an inertial navigation system, a first running data that is measured by an inertial measurement unit IMU in a first specified duration, where the first running data includes running data of each of N axes that is measured by the IMU in the first specified duration, and N is a positive integer greater than or equal to 1, and preferably, the first specified duration is 1 second and N is 6; determining, by the inertial navigation system, a first standard deviation corresponding to the running data of each axis in the first specified duration, that is, determining N first standard deviations; matching, by the inertial navigation system, the N first standard deviations with a prestored database, to determine N second standard deviations that are the same as the N first standard deviations; and determining, by the inertial navigation system in the prestored database, a piece of first information corresponding to each of the N second standard deviations, where the first piece of information includes a first probability that the second standard deviation is static, and a weight corresponding to the second standard deviation. Specifically, the N first standard deviations are from the N axes respectively, and the second standard deviations included in the database are also from the N axes. The first information includes the first probability that the second standard deviation is static, to be specific, the first probability that an axis corresponding to the second standard deviation is static. The weight corresponding to the second standard deviation is a weight of the axis corresponding to the second standard deviation. The inertial navigation system multiplies the first probability in each of the N pieces of first information by the corresponding weight, and adds N values obtained through the multiplication, where a value obtained through the addition is determined as a second probability that the N first standard deviations are static; and when the second probability is greater than or equal to the static probability threshold, the inertial navigation system determines that a device in which the inertial navigation system is located is in a static state in the first specified duration; or when the second probability is less than the static probability threshold, determines that a device in which the inertial navigation system is located is in a moving state in the first specified duration.

In this embodiment of the present invention, the inertial navigation system measures, by using the IMU, a running data of N axes in the first specified duration; calculates first standard deviations corresponding to the running data of the N axes; queries the database for the calculated N first standard deviations, to determine the N second standard deviations that are the same as the N first standard deviations; determines, in the database, the first probabilities corresponding to the N second standard deviations respectively, and the weights corresponding to axes on which the N second standard deviations are located; determines, based on the N determined first probabilities and weights corresponding to the N axes, the second probability that the device in which the inertial navigation system is located is static in the first specified duration; compares the second probability with the static probability threshold; and when the second probability is greater than or equal to the static probability threshold, determines that the device in which the inertial navigation system is located is static in the first specified duration. According to the foregoing method, accuracy of determining a static state is improved.

In one embodiment, a correspondence between the second standard deviation and the weight of the axis on which the second standard deviation is located is formed through the following process: determining, by the inertial navigation system, sample data, measured by the IMU in second specified duration, of any axis; determining, by the inertial navigation system, sample data corresponding to each first specified duration in the second specified duration as static data or dynamic data, determining a static standard deviation based on the static data, and determining a dynamic standard deviation based on the dynamic data, where a value of the first specified duration in the second specified duration is determined in a form of a sliding window; grouping a plurality of determined static standard deviations based on first specified threshold ranges, and determining a quantity of static standard deviations in each first specified threshold range; and dividing the first threshold specified range into a plurality of groups, where values of fixed intervals are grouped into one group to obtain a static standard deviation distribution histogram; and grouping a plurality of determined dynamic sample standard-deviations based on second specified threshold ranges, determining a quantity of dynamic sample standard-deviations in each second specified threshold range; and dividing the first threshold specified range into a plurality of groups, where values of fixed intervals are grouped into one group to obtain a dynamic standard deviation distribution histogram; separately performing curve fitting on the histogram of the static standard deviations and the distribution histogram of the dynamic standard deviations, and normalizing curves obtained through the fitting, to determine a static standard deviation curve and a dynamic standard deviation curve; placing the static standard deviation curve and the dynamic standard deviation curve in a same coordinate system, and determining an area of an intersecting part of the static standard deviation curve and the dynamic standard deviation curve; and determining a reciprocal of the area of the intersecting part as a weight of the plurality of static standard deviations and the plurality of dynamic sample standard-deviations corresponding to any axis. The weights of the N axes are determined in the foregoing calculation manner.

In one embodiment, a correspondence between the second standard deviation and the first probability is formed through the following process: placing the static standard deviation curve and the dynamic standard deviation curve in a same coordinate system, where when the area of the intersecting part of the static standard deviation curve and the dynamic standard deviation curve is determined, each of the static standard deviation curve and the dynamic standard deviation curve has two intersection points with a horizontal axis of the coordinate system; in the two intersection points, an intersection point a has a shorter distance to an origin of the coordinate system, and an intersection point b has a longer distance to the origin of the coordinate system: and an intersection point of the static standard deviation curve and the dynamic standard deviation curve is an intersection point c; and when the second standard deviation is a value less than or equal to the intersection point a, a probability that the second standard deviation is static is a corresponding probability value of the second standard deviation on the static standard deviation curve; when a second data is a value greater than or equal to the intersection point b, a probability that the second standard deviation is static is 0; and when the second data is a value greater than the point a and less than the point b, a probability that the second standard deviation is static is: a ratio of the corresponding probability value of the second standard deviation on the static standard deviation curve to a sum of the corresponding probability value of the second standard deviation on the static standard deviation curve and a corresponding probability value of the second standard deviation on the dynamic standard deviation curve.

According to a second aspect, an embodiment of the present invention provides a static state determining apparatus, including:

an obtaining module, configured to obtain first running data that is measured by an inertial measurement unit IMU in first specified duration, where the first running data includes running data of each of N axes that is measured by the IMU in the first specified duration, and N is a positive integer greater than or equal to 1; a determining module, configured to determine N first standard deviations of the first running data; a matching module, configured to match the N first standard deviations with a prestored database, to determine N second standard deviations that are the same as the N first standard deviations; a searching module, configured to determine, in the prestored database, first information corresponding to each of the N second standard deviations, where the first information includes a first probability that the second standard deviation is static, and a weight corresponding to the second standard deviation; a processing module, configured to: multiply the first probability in each of the N pieces of first information by the corresponding weight, and add N values obtained through the multiplication, where a value obtained through the addition is determined as a second probability that the N first standard deviations are static; and a judgment module, configured to: when the second probability is greater than or equal to the static probability threshold, determine that a device in which the inertial navigation system is located is in a static state in the first specified duration.

In this embodiment of the present invention, an inertial navigation system measures, by using the IMU, running data of N axes in the first specified duration; calculates first standard deviations corresponding to the running data of the N axes; queries the database for the calculated N first standard deviations, to determine the N second standard deviations that are the same as the N first standard deviations; determines, in the database, the first probabilities corresponding to the N second standard deviations respectively, and weights corresponding to axes on which the N second standard deviations are located; determines, based on the N determined first probabilities and weights corresponding to the N axes, the second probability that the device in which the inertial navigation system is located is static in the first specified duration; compares the second probability with the static probability threshold; and when the second probability is greater than or equal to the static probability threshold, determines that the device in which the inertial navigation system is located is static in the first specified duration. According to the foregoing method, accuracy of determining a static state is improved.

In one embodiment, a correspondence between the second standard deviation and the weight is formed through the following process: determining static data and dynamic data, measured by the IMU in second specified duration, of any axis; determining, in the second specified duration, static data corresponding to each first specified duration and dynamic sample data corresponding to the first specified duration, determining a static standard deviation based on the static data corresponding to the first specified duration, and determining a dynamic sample standard-deviation based on the dynamic sample data corresponding to the first specified duration; grouping a plurality of determined static standard deviations based on first specified threshold ranges, and determining a quantity of static standard deviations in each first specified threshold range, to obtain a distribution histogram of the static standard deviations; and grouping a plurality of determined dynamic sample standard-deviations based on second specified threshold ranges, and determining a quantity of dynamic standard deviations in each second specified threshold range, to obtain a distribution histogram of the dynamic standard deviations; separately performing curve fitting on the histogram of the static standard deviations and the distribution histogram of the dynamic standard deviations, and normalizing curves obtained through the fitting, to determine a static standard deviation curve and a dynamic standard deviation curve; placing the static standard deviation curve and the dynamic standard deviation curve in a same coordinate system, and determining an area of an intersecting part of the static standard deviation curve and the dynamic standard deviation curve; and determining a reciprocal of the area of the intersecting part as a weight of the plurality of static standard deviations and the plurality of dynamic standard deviations corresponding to any axis.

In one embodiment, a correspondence between the second standard deviation and the first probability is formed through the following process: placing the static standard deviation curve and the dynamic standard deviation curve in a same coordinate system, where when the area of the intersecting part of the static standard deviation curve and the dynamic standard deviation curve is determined, each of the static standard deviation curve and the dynamic standard deviation curve has two intersection points with a horizontal axis of the coordinate system; in the two intersection points, an intersection point a has a shorter distance to an origin of the coordinate system, and an intersection point b has a longer distance to the origin of the coordinate system; and an intersection point of the static standard deviation curve and the dynamic standard deviation curve is an intersection point c; and when the second standard deviation is a value less than or equal to the intersection point a, a probability that the second standard deviation is static is a corresponding probability value of the second standard deviation on the static standard deviation curve; when the second data is a value greater than or equal to the intersection point b, a probability that the second standard deviation is static is 0; and when the second data is a value greater than the point a and less than the point b, a probability that the second standard deviation is static is: a ratio of the corresponding probability value of the second standard deviation on the static standard deviation curve to a sum of the corresponding probability value of the second standard deviation on the static standard deviation curve and a corresponding probability value of the second standard deviation on the dynamic standard deviation curve.

In one embodiment, N is 6.

According to a third aspect, an embodiment of the present invention provides a static state determining apparatus, including a processor and a memory connected to the processor, where

the memory is configured to store program code executed by the processor; and

the processor is configured to execute the program code stored in the memory to perform the following process:

obtaining first running data that is measured by an inertial measurement unit IMU in first specified duration, where the first running data includes running data of each of N axes that is measured by the IMU in the first specified duration, and N is a positive integer greater than or equal to 1; determining N first standard deviations of the first running data; matching the N first standard deviations with a prestored database, to determine N second standard deviations that are the same as the N first standard deviations; determining, in the prestored database, first information corresponding to each of the N second standard deviations, where the first information includes a first probability that the second standard deviation is static, and a weight corresponding to the second standard deviation; multiplying the first probability in each of the N pieces of first information by the corresponding weight, and adding N values obtained through the multiplication, where a value obtained through the addition is determined as a second probability that the N first standard deviations are static; and when the second probability is greater than or equal to the static probability threshold, determining that a device in which the inertial navigation system is located is in a static state in the first specified duration.

In the embodiments of the present invention, an inertial navigation system measures, by using the IMU, running data of N axes in the first specified duration; calculates first standard deviations corresponding to the running data of the N axes; queries the database for the calculated N first standard deviations, to determine the N second standard deviations that are the same as the N first standard deviations; determines, in the database, the first probabilities corresponding to the N second standard deviations respectively, and the weights corresponding to axes on which the N second standard deviations are located; determines, based on the N determined first probabilities and weights corresponding to the N axes, the second probability that the device in which the inertial navigation system is located is static in the first specified duration; compares the second probability with the static probability threshold; and when the second probability is greater than or equal to the static probability threshold, determines that the device in which the inertial navigation system is located is static in the first specified duration. According to the foregoing method, accuracy of determining a static state is improved.

### BRIEF DESCRIPTION OF DRAWINGS

FIG. 1 shows a static standard deviation curve and a static standard deviation curve according to an embodiment of the present invention:

FIG. 2 is a schematic flowchart of determining the static standard deviation curve and the static standard deviation curve in FIG. 1 according to an embodiment of the present invention;

FIG. 3 shows original data of an IMU according to an embodiment of the present invention;

FIG. 4 shows static standard deviation curves and static standard deviation curves along axes according to an embodiment of the present invention;

FIG. 5 shows curves of probabilities that standard deviations of overlapping parts of static standard deviation curves and dynamic standard deviation curves along axes according to an embodiment of the present invention;

FIG. 6 is a schematic flowchart of a static state determining method according to an embodiment of the present invention;

FIG. 7 is a schematic structural diagram of a static state determining apparatus according to an embodiment of the present invention: and

FIG. 8 is a schematic structural diagram of hardware of a static state determining apparatus according to an embodiment of the present invention.

### DESCRIPTION OF EMBODIMENTS

The following further describes embodiments of the present invention in detail with reference to the accompanying drawings in this specification. It should be understood that the embodiments described herein are merely used to explain the present invention but are not intended to limit the present invention.

An inertial navigation system INS is a dead reckoning system, and includes an inertial measurement unit IMU and an inertial navigation mechanization algorithm. However, due to a sensor error in the INS, an INS error becomes larger as time increases. To resolve the problem that the INS error becomes larger as the time increases and to reduce the INS error, an embodiment of the present invention provides a static state determining method, to improve accuracy of determining a static state.

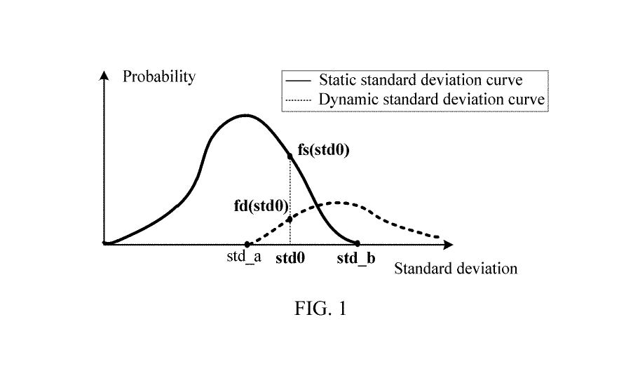

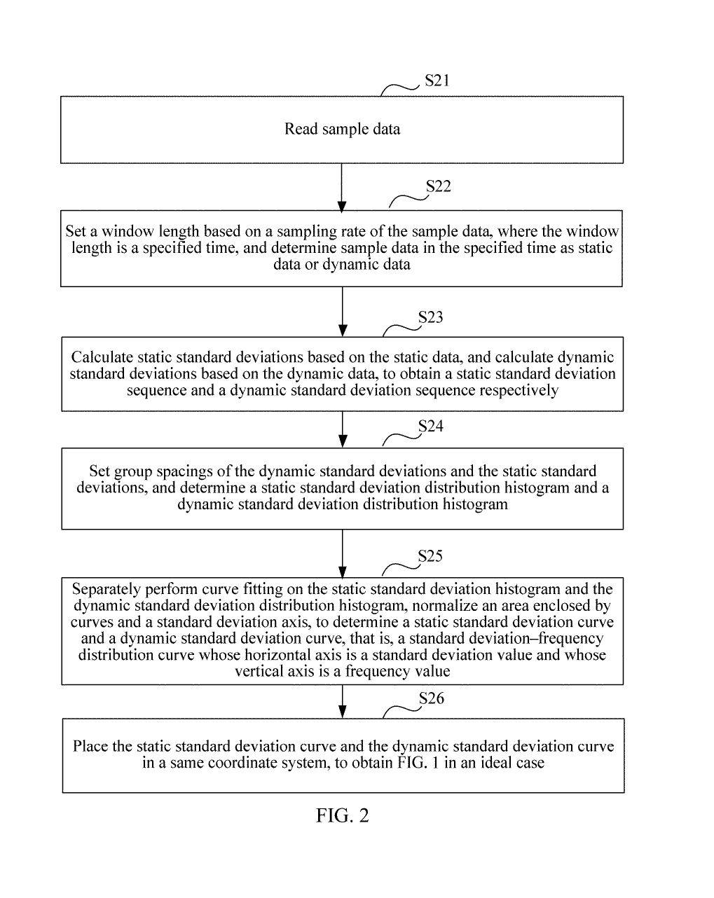

In this embodiment of the present invention, a static standard deviation curve and a dynamic standard deviation curve shown in FIG. 1 are obtained through fitting, by using any axis as an example. A specific process is shown in FIG. 2:

in operations 21: Reading sample data.

in operation 22: Setting a window length based on a sampling rate of the sample data, where the window length is a specified time, and determine sample data in the specified time as static data or dynamic data.

in operation 23: Calculating static standard deviations based on the static data, and calculate dynamic standard deviations based on the dynamic data, to obtain a static standard deviation sequence and a dynamic standard deviation sequence respectively.

in operation 24: Setting group spacings of the dynamic standard deviations and the static standard deviations, and determine a static standard deviation distribution histogram and a dynamic standard deviation distribution histogram.

For example, it is assumed that values of the dynamic standard deviations and the static standard deviations range from 0 to 100, group spacings are set by using 5 as a step, and then a plurality of groups, 0 . . . 4, 5 . . . 9, 10 . . . 14, . . . , 96-100) are obtained through division. In this embodiment of the present invention, division of the group spacings may be determined as required. This is not limited in the present invention.

In operation 25: Separately performing curve fitting on the static standard deviation histogram and the dynamic standard deviation distribution histogram, normalize an area enclosed by curves and a standard deviation (STD) axis, to determine a static standard deviation curve and a dynamic standard deviation curve, that is, a standard deviation-frequency distribution curve whose horizontal axis is a standard deviation value and whose vertical axis is a frequency value.

Specifically, the normalization may be performed by using the following method. An area S enclosed by curves and an STD axis is first calculated, where the area enclosed by the curves is solved by using a trapezoidal integration method, and then a frequency obtained after the STDs are normalized is f′_{std}.

f′_{std}=f_{std}/S

In operation 26: Placing the static standard deviation curve and the dynamic standard deviation curve in a same coordinate system, to obtain FIG. 1 in an ideal case.

In FIG. 1, according to the Bernouli Distribution Principle, a probability that any standard deviation is static can be calculated. Each of the static standard deviation curve and the dynamic standard deviation curve has two intersection points with a horizontal axis of the coordinate system; in the two intersection points, an intersection point std_a has a shorter distance to an origin of the coordinate system, and an intersection point std_b has a longer distance to the origin of the coordinate system: and an intersection point of the static standard deviation curve and the dynamic standard deviation curve is an intersection point std_c; and when the standard deviation is a value less than or equal to the intersection point std_a, a probability that the standard deviation is static is a corresponding probability value of the standard deviation on the static standard deviation curve, that is, a probability that the standard deviation is static is 100%; when the standard deviation is a value greater than or equal to the intersection point std_b, a probability that the standard deviation is static is 0; and when the standard deviation std0 is a value greater than the point std_a and less than the point std_b, a probability that the standard deviation is static is: a ratio of the corresponding probability value fs(std0) of the standard deviation std0 on the static standard deviation curve to a sum of the corresponding probability value fs(std0) of the standard deviation on the static standard deviation curve and a corresponding probability value fs(std0) of the standard deviation std0 on the dynamic standard deviation curve, that is, a probability that std0 is static is:

$${P}_{static} ( {std}_{0} ) = \frac{{f}_{s} ( {std}_{0} )}{{f}_{s} ( {std}_{0} ) + {f}_{d} ( {std}_{0} )}$$

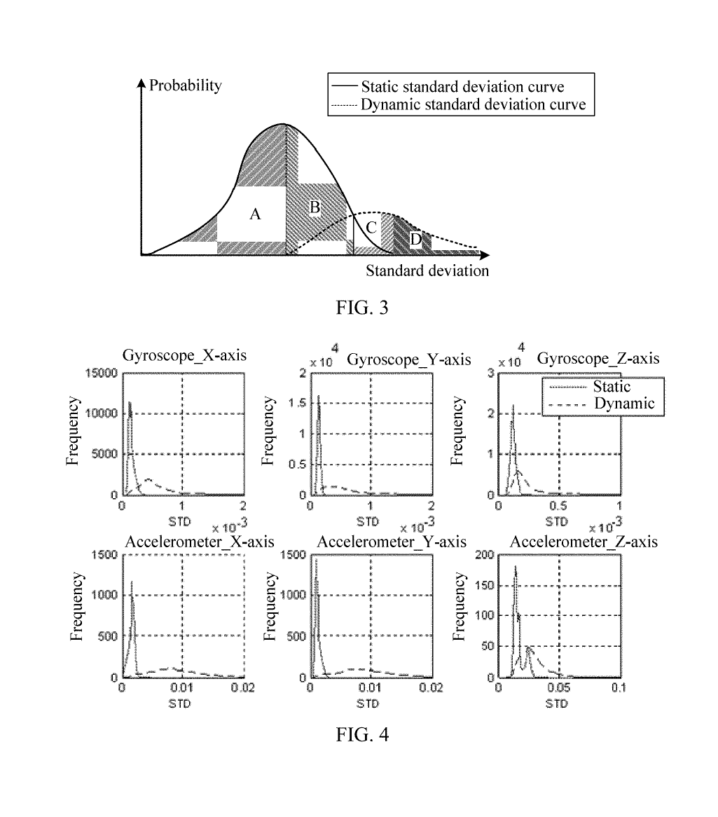

For example, as shown in FIG. 3, a probability that a standard deviation of a region A is static is 100%, probabilities that standard deviations of a region B and a region C are static are calculated by using the foregoing formula, and a probability that a standard deviation of a region D) is static is 0.

A reciprocal of the area enclosed by the static standard deviation curve and the dynamic standard deviation curve and the horizontal axis is a weight K of the axis. The determined weight K, a probability that any standard deviation is static, and the standard deviations are determined as a database, and subsequently, the database is used when a status of new data needs to be determined.

In this embodiment of the present invention, FIG. 1 is used for calculating the weight K. It is assumed that a function expression of an overlapping part of the static standard deviation curve and the dynamic standard deviation curve is f(x), a<x<b; and an enclosed area is A, then

A=∫ₐ^{b}f(x)dx

Finally, after normalization is performed, an expression of the weight K is determined as:

$${K}_{i} = \frac{1}{Σ \frac{1}{{A}_{i}}} \cdot \frac{1}{{A}_{i}}$$

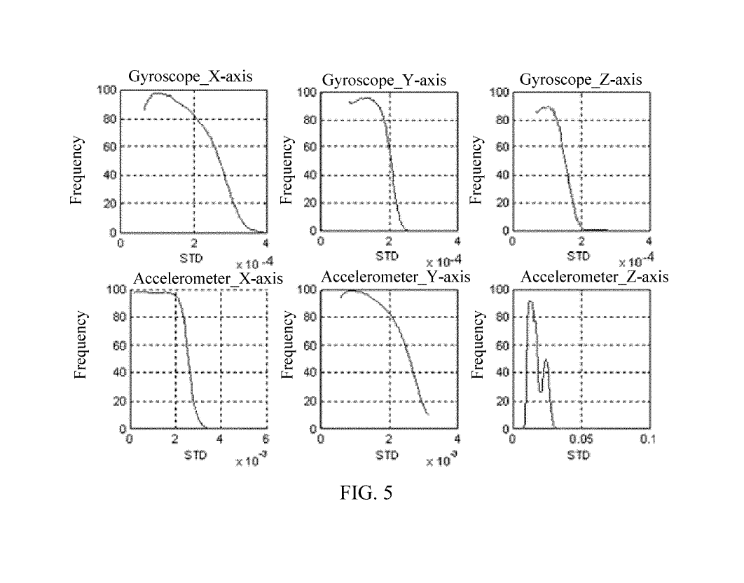

In this embodiment of the present invention, forming of the database (that is, a standard deviation-probability distribution lookup table) is described by using data of six axes that is collected by a vehicle inertial sensor. Sample data is from a plurality of sports car experiments in different application scenarios. During a process of a sports car experiment, a car stopping phenomenon frequently occurs due to traffic jam or intentional reasons, and original output data is collected. The original data includes angular velocities collected by a gyroscope in three directions of an X-axis, a Y-axis, and a Z-axis, and accelerations collected by an accelerometer in the three directions of the X-axis, the Y-axis, and the Z-axis. The collected data is processed according to operations 21 to 26, to obtain static standard deviation curves and dynamic standard deviation curves of axes shown in FIG. 4. A curve of probabilities that a standard deviation of an overlapping part of a static standard deviation curve and a static standard deviation of each axis shown in FIG. 5 are determined as static is determined. In addition, a reciprocal of an area of the overlapping part of axes and a value obtained after normalization are determined, as shown in Table 1 below:

TABLE 1

| | Gyroscope_X- | Gyroscope_Y- | Gyroscope_Z- | Acceleration_X- | Acceleration_Y- | Acceleration_Z- |
|---|---|---|---|---|---|---|
| | axis | axis | axis | axis | axis | axis |
| Reciprocal of an | 7.0918 | 10.2050 | 3.0086 | 21.7084 | 15.7428 | 2.4484 |
| area | | | | | | |
| K (after | 0.1178 | 0.1695 | 0.0500 | 0.3606 | 0.2615 | 0.0407 |
| normalization) | | | | | | |

The foregoing data is recorded in the database, and when a probability that any standard deviation is static needs to be determined, the data in the database is used for the following calculation: A probability that each standard deviation is static is obtained by performing weighted averaging on a probability that any standard deviation of each of N axes is static and a weight of the axis, that is:

$$P ( std 0 ) = {\sum }_{i = 1}^{n} {K}_{i} * {P}_{i} ( std 0 )$$

n represents a quantity of axes and i represents an i^{th} axis.

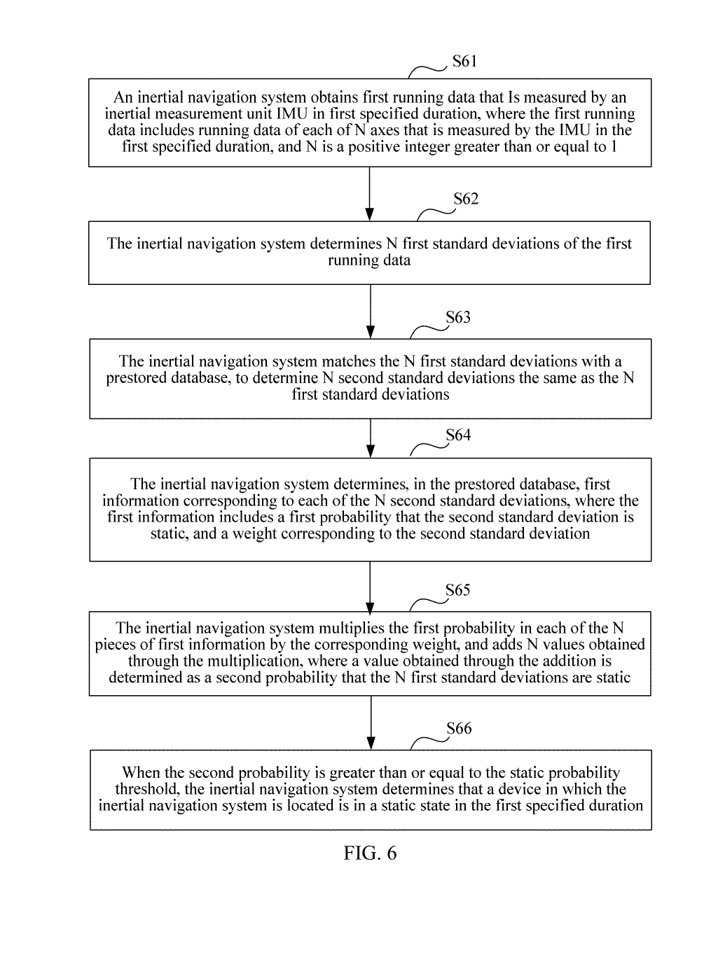

An embodiment of the present invention further provides a static state determining method. As shown in FIG. 6, the method includes the following process:

In operation 61: An inertial navigation system obtains first running data that is measured by an inertial measurement unit IMU in first specified duration, where the first running data includes running data of each of N axes that is measured by the IMU in the first specified duration, and N is a positive integer greater than or equal to 1.

In operation 62: The inertial navigation system determines N first standard deviations of the first running data.

In operation 63: The inertial navigation system matches the N first standard deviations with a prestored database, to determine N second standard deviations the same as the N first standard deviations.

In operation 64: The inertial navigation system determines, in the prestored database, first information corresponding to each of the N second standard deviations, where the first information includes a first probability that the second standard deviation is static, and a weight corresponding to the second standard deviation.

In operation 65: The inertial navigation system multiplies the first probability in each of the N pieces of first information by the corresponding weight, and adds N values obtained through the multiplication, where a value obtained through the addition is determined as a second probability that the N first standard deviations are static.

In operation 66: When the second probability is greater than or equal to the static probability threshold, the inertial navigation system determines that a device in which the inertial navigation system is located is in a static state in the first specified duration.

In this embodiment of the present invention, the inertial navigation system measures, by using the IMU, running data of N axes in the first specified duration; calculates first standard deviations corresponding to the running data of the N axes; queries the database for the calculated N first standard deviations, to determine the N second standard deviations the same as the N first standard deviations; determines, in the database, the first probabilities corresponding to the N second standard deviations respectively, and the weights corresponding to axes on which the N second standard deviations are located; determines, based on the N determined first probabilities and weights corresponding to the N axes, the second probability that the device in which the inertial navigation system is located is static in the first specified duration; compares the second probability with the static probability threshold; and when the second probability is greater than or equal to the static probability threshold, determines that the device in which the inertial navigation system is located is static in the first specified duration. According to the foregoing method, accuracy of determining a static state is improved.

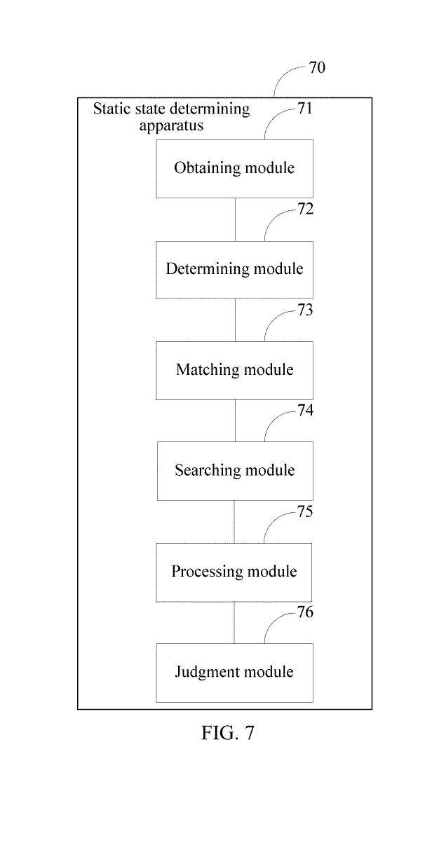

Based on a same inventive concept, an embodiment of the present invention provides a static state determining apparatus 70. As shown in FIG. 7, the apparatus includes:

an obtaining module 71, configured to obtain first running data that is measured by an inertial measurement unit IMU in first specified duration, where the first running data includes running data of each of N axes that is measured by the IMU in the first specified duration, and N is a positive integer greater than or equal to 1;

a determining module 72, configured to determine N first standard deviations of the first running data;

a matching module 73, configured to match the N first standard deviations with a prestored database, to determine N second standard deviations that are the same as the N first standard deviations;

a searching module 74, configured to determine, in the prestored database, a piece of first information corresponding to each of the N second standard deviations, where the first information includes a first probability that the second standard deviation is static, and a weight corresponding to the second standard deviation;

a processing module 75, configured to: multiply the first probability in each of the N pieces of first information by the corresponding weight, and add N values obtained through the multiplication, where a value obtained through the addition is determined as a second probability that the N first standard deviations are static; and

a judgment module 76, configured to: when the second probability is greater than or equal to the static probability threshold, determine that a device in which the inertial navigation system is located is in a static state in the first specified duration.

In this embodiment of the present invention, an inertial navigation system measures, by using the IMU, running data of N axes in the first specified duration; calculates first standard deviations corresponding to the running data of the N axes; queries the database for the calculated N first standard deviations, to determine the N second standard deviations the same as the N first standard deviations; determines, in the database, the first probabilities corresponding to the N second standard deviations respectively, and the weights corresponding to axes on which the N second standard deviations are located; determines, based on the N determined first probabilities and weights corresponding to the N axes, the second probability that the device in which the inertial navigation system is located is static in the first specified duration; compares the second probability with the static probability threshold; and when the second probability is greater than or equal to the static probability threshold, determines that the device in which the inertial navigation system is located is static in the first specified duration. According to the foregoing method, accuracy of determining a static state is improved.

In one embodiment, a correspondence between the second standard deviation and the weight is formed through the following process:

determining sample data, measured by the IMU in second specified duration, of any axis;

determining sample data corresponding to each first specified duration in the second specified duration as static data or dynamic data, determining a static standard deviation based on the static data, and determining a dynamic standard deviation based on the dynamic data;

grouping a plurality of determined static standard deviations based on first specified threshold ranges, and determining a quantity of static standard deviations in each first specified threshold range, to obtain a distribution histogram of the static standard deviations; and grouping a plurality of determined dynamic sample standard-deviations based on second specified threshold ranges, and determining a quantity of dynamic sample standard-deviations in each second specified threshold range, to obtain a distribution histogram of the dynamic standard deviations;

separately performing curve fitting on the histogram of the static standard deviations and the distribution histogram of the dynamic standard deviations, and normalizing curves obtained through the fitting, to determine a static standard deviation curve and a dynamic standard deviation curve;

placing the static standard deviation curve and the dynamic standard deviation curve in a same coordinate system, and determining an area of an intersecting part of the static standard deviation curve and the dynamic standard deviation curve; and

determining a reciprocal of the area of the intersecting part as a weight of the plurality of static standard deviations and the plurality of dynamic standard deviations corresponding to any axis.

In one embodiment, a correspondence between the second standard deviation and the first probability is formed through the following process, including:

placing the static standard deviation curve and the dynamic standard deviation curve in a same coordinate system, where when the area of the intersecting part of the static standard deviation curve and the dynamic standard deviation curve is determined, each of the static standard deviation curve and the dynamic standard deviation curve has two intersection points with a horizontal axis of the coordinate system; in the two intersection points, an intersection point a has a shorter distance to an origin of the coordinate system, and an intersection point b has a longer distance to the origin of the coordinate system; and an intersection point of the static standard deviation curve and the dynamic standard deviation curve is an intersection point c; and

when the second standard deviation is a value less than or equal to the intersection point a, a probability that the second standard deviation is static is a corresponding probability value of the second standard deviation on the static standard deviation curve;

when the second data is a value greater than or equal to the intersection point b, a probability that the second standard deviation is static is 0; and

when the second data is a value greater than the point a and less than the point b, a probability that the second standard deviation is static is: a ratio of the corresponding probability value of the second standard deviation on the static standard deviation curve to a sum of the corresponding probability value of the second standard deviation on the static standard deviation curve and a corresponding probability value of the second standard deviation on the dynamic standard deviation curve.

In one embodiment. N is 6.

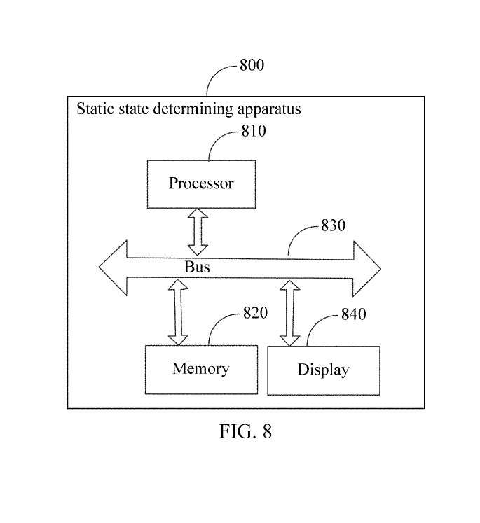

An embodiment of the present invention provides a static state determining apparatus 800. As shown in FIG. 8, the static state determining apparatus 800 includes a processor 810, a memory 820 connected to the processor, a display 840 that is connected to a bus 830 and that is configured to display a static state, and the memory 820 and the processor 810 are connected to each other by using the bus 830.

The memory 820 is configured to store program code executed by the processor.

The processor 810 is configured to execute the program code stored in the memory to perform any step counting method in the foregoing embodiments, for example, perform the following process:

obtaining first running data that is measured by an inertial measurement unit IMU in first specified duration, where the first running data includes running data of each of N axes that is measured by the IMU in the first specified duration, and N is a positive integer greater than or equal to 1; determining N first standard deviations of the first running data; matching the N first standard deviations with a prestored database, to determine N second standard deviations the same as the N first standard deviations; determining, in the prestored database, first information corresponding to each of the N second standard deviations, where the first information includes a first probability that the second standard deviation is static, and a weight corresponding to the second standard deviation; multiplying the first probability in each of the N pieces of first information by the corresponding weight, and adding N values obtained through the multiplication, where a value obtained through the addition is determined as a second probability that the N first standard deviations are static; and when the second probability is greater than or equal to the static probability threshold, determining that a device in which the inertial navigation system is located is in a static state in the first specified duration.

Persons skilled in the art should understand that the embodiments of the present invention may be provided as a method, a system, or a computer program product. Therefore, the present invention may use a form of hardware only embodiments, software only embodiments, or embodiments with a combination of software and hardware. Moreover, the present invention may use a form of a computer program product that is implemented on one or more computer-usable storage media (including but not limited to a disk memory, a CD-ROM, an optical memory, and the like) that include computer-usable program code.

The present invention is described with reference to the flowcharts and/or block diagrams of the method, the device (system), and the computer program product according to the embodiments of the present invention. It should be understood that computer program instructions may be used to implement each process and/or each block in the flowcharts and/or the block diagrams and a combination of a process and/or a block in the flowcharts and/or the block diagrams. These computer program instructions may be provided for a general-purpose computer, a dedicated computer, an embedded processor, or a processor of any other programmable data processing device to generate a machine, so that the instructions executed by a computer or a processor of any other programmable data processing device generate an apparatus for implementing a specific function in one or more processes in the flowcharts and/or in one or more blocks in the block diagrams.

These computer program instructions may be stored in a computer readable memory that can instruct the computer or any other programmable data processing device to work in a specific manner, so that the instructions stored in the computer readable memory generate an artifact that includes an instruction apparatus. The instruction apparatus implements a specific function in one or more processes in the flowcharts and/or in one or more blocks in the block diagrams.

These computer program instructions may be loaded onto a computer or another programmable data processing device, so that a series of operations are performed on the computer or the another programmable device, thereby generating computer-implemented processing. Therefore, the instructions executed on the computer or the another programmable device provide operations for implementing a specific function in one or more processes in the flowcharts and/or in one or more blocks in the block diagrams.

Although some embodiments of the present invention have been described, persons skilled in the art can make changes and modifications to these embodiments once they learn the basic inventive concept. Therefore, the following claims are intended to be construed as to cover the preferred embodiments and all changes and modifications falling within the scope of the present invention.

Obviously, persons skilled in the art can make various modifications and variations to the present invention without departing from the spirit and scope of the present invention. The present invention is intended to cover these modifications and variations provided that they fall within the scope of protection defined by the following claims and their equivalent technologies.

1. A static state determining method, comprising:
obtaining, by an inertial navigation system, a first running data that is measured by an inertial measurement unit (IMU) in a first specified duration, wherein the first running data comprises a piece of running data of each of N axes that is measured by the IMU in the first specified duration, and wherein N is a positive integer greater than or equal to 1;
determining, by the inertial navigation system, N first standard deviations of the first running data;
matching, by the inertial navigation system, the N first standard deviations with a database, to determine N second standard deviations that are the same as the N first standard deviations;
determining, by the inertial navigation system in the database, a piece of first information corresponding to each of the N second standard deviations, wherein the piece of first information comprises a first probability that the second standard deviation is static, and a weight corresponding to the second standard deviation;
multiplying, by the inertial navigation system, the first probability in each of the N pieces of first information by the corresponding weight, and adding N values obtained through the multiplication, wherein a value obtained through the addition is a second probability that the N first standard deviations are static; and
in response to determining that the second probability is greater than or equal to the static probability threshold, determining that a device in which the inertial navigation system is located is in a static state in the first specified duration.

2. The method according to claim 1, wherein a correspondence between the second standard deviation and the weight is formed through the following operations:
determining, by the inertial navigation system, a first sample data, measured by the IMU in a second specified duration, of any axis of the N axes, the second specified duration including a plurality of first specified durations;
determining, by the inertial navigation system, a second sample data corresponding to each of a plurality of first specified durations in the second specified duration as static data or dynamic data, a static standard deviation based on the static data, and a dynamic standard deviation based on the dynamic data;
grouping a plurality of determined static standard deviations based on first specified threshold ranges, and determining a quantity of static standard deviations in each of the first specified threshold ranges, to obtain a distribution histogram of the static standard deviations;
grouping a plurality of determined dynamic standard deviations based on second specified threshold ranges, and determining a quantity of dynamic standard deviations in each of the second specified threshold ranges, to obtain a distribution histogram of the dynamic standard deviations;
separately performing a curve fitting operation on the histogram of the static standard deviations and the distribution histogram of the dynamic standard deviations, and normalizing curves obtained through the curve fitting operation, to determine a static standard deviation curve and a dynamic standard deviation curve;
placing the static standard deviation curve and the dynamic standard deviation curve in a same coordinate system, and determining an area of an intersecting part of the static standard deviation curve and the dynamic standard deviation curve; and
determining a reciprocal of the area of the intersecting part as a weight of the plurality of static standard deviations and the plurality of dynamic standard deviations corresponding to any axis of the N axes.

3. The method according to claim 2, wherein a correspondence between the second standard deviation and the first probability is formed through the following operations:
placing the static standard deviation curve and the dynamic standard deviation curve in a same coordinate system, wherein when the area of the intersecting part of the static standard deviation curve and the dynamic standard deviation curve is determined, each of the static standard deviation curve and the dynamic standard deviation curve has two intersection points with a horizontal axis of the coordinate system, with an intersection point a of the two intersection points having a shorter distance to an origin of the coordinate system than an intersection point b of the two intersection points;
wherein an intersection point of the static standard deviation curve and the dynamic standard deviation curve is an intersection point c;
wherein when the second standard deviation is a value less than or equal to the intersection point a, a probability that the second standard deviation is static is a corresponding probability value of the second standard deviation on the static standard deviation curve;
wherein when the second standard deviation is a value greater than or equal to the intersection point b, a probability that the second standard deviation is static is 0; and
wherein when the second standard deviation is a value greater than the point a and less than the intersection point b, a probability that the second standard deviation is static is: a ratio of the corresponding probability value of the second standard deviation on the static standard deviation curve to a sum of the corresponding probability value of the second standard deviation on the static standard deviation curve and a corresponding probability value of the second standard deviation on the dynamic standard deviation curve.

4. The method according to claim 1, wherein N is 6.

5. A static state determining apparatus, comprising:
an obtaining module, configured to obtain a first running data that is measured by an inertial measurement unit IMU in a first specified duration, wherein the first running data comprises a piece of running data of each of N axes that is measured by the IMU in the first specified duration, and wherein N is a positive integer greater than or equal to 1;
a determining module, configured to calculate N first standard deviations of the first running data;
a matching module, configured to match the N first standard deviations with a database, to determine N second standard deviations that are the same as the N first standard deviations;
a searching module, configured to determine, in the database, a piece of first information corresponding to each of the N second standard deviations, wherein the piece of first information comprises a first probability that the second standard deviation is static, and a weight corresponding to the second standard deviation;
a processing module, configured to: multiply the first probability in each of the N pieces of first information by the corresponding weight, and add N values obtained through the multiplication, wherein a value obtained through the addition is a second probability that the N first standard deviations are static; and
a judgment module, configured to: determine whether the second probability is greater than the static probability threshold; and if the second probability is greater than or equal to the static probability threshold, determine that a device in which the inertial measurement unit is located is in a static state in the first specified duration.

6. The apparatus according to claim 5, wherein the searching module is further configured to form a correspondence between the second standard deviation and the weight in the following operations:
determining, by the inertial navigation system, a first sample data, measured by the IMU in a second specified duration, of any axis of the N axes, the second specified duration including a plurality of first specified durations;
determining, by the inertial navigation system, a second sample data corresponding to each of the plurality of first specified durations in the second specified duration as static data or dynamic data, a static standard deviation based on the static data, and a dynamic standard deviation based on the dynamic data;
grouping a plurality of determined static standard deviations based on first specified threshold ranges, and determining a quantity of static standard deviations in each of the first specified threshold ranges, to obtain a distribution histogram of the static standard deviations;
grouping a plurality of determined dynamic standard deviations based on second specified threshold ranges, and determining a quantity of dynamic standard deviations in each of the second specified threshold ranges, to obtain a distribution histogram of the dynamic standard deviations;
separately performing a curve fitting operation on the histogram of the static standard deviations and the distribution histogram of the dynamic standard deviations, and normalizing curves obtained through the curve fitting operation, to determine a static standard deviation curve and a dynamic standard deviation curve;
placing the static standard deviation curve and the dynamic standard deviation curve in a same coordinate system, and determining an area of an intersecting part of the static standard deviation curve and the dynamic standard deviation curve; and
determining a reciprocal of the area of the intersecting part as a weight of the plurality of static standard deviations and the plurality of dynamic standard deviations corresponding to any axis of the N axes.

7. The apparatus according to claim 6, wherein the processing module is further configured to form a correspondence between the second standard deviation and the first probability in the following operations:
placing the static standard deviation curve and the dynamic standard deviation curve in a same coordinate system, wherein when the area of the intersecting part of the static standard deviation curve and the dynamic standard deviation curve is determined, each of the static standard deviation curve and the dynamic standard deviation curve has two intersection points with a horizontal axis of the coordinate system, with an intersection point a of the two intersection points having a shorter distance to an origin of the coordinate system than an intersection point b of the two intersection points;
wherein an intersection point of the static standard deviation curve and the dynamic standard deviation curve is an intersection point c;
wherein when the second standard deviation is a value less than or equal to the intersection point a, a probability that the second standard deviation is static is a corresponding probability value of the second standard deviation on the static standard deviation curve;
wherein when the second standard deviation is a value greater than or equal to the intersection point b, a probability that the second standard deviation is static is 0; and
wherein when the second standard deviation is a value greater than the point a and less than the intersection point b, a probability that the second standard deviation is static is: a ratio of the corresponding probability value of the second standard deviation on the static standard deviation curve to a sum of the corresponding probability value of the second standard deviation on the static standard deviation curve and a corresponding probability value of the second standard deviation on the dynamic standard deviation curve.

8. The apparatus according to claim 5, wherein N is 6.

9. A non-transitory computer-readable medium for storing instructions, which when executed by a processor, cause the processor to perform a method, the method comprising:
obtaining, by an inertial navigation system, a first running data that is measured by an inertial measurement unit (IMU) in a first specified duration, wherein the first running data comprises a pierce of running data of each of N axes that is measured by the IMU in the first specified duration, and wherein N is a positive integer greater than or equal to 1;
determining, by the inertial navigation system, N first standard deviations of the first running data;
matching, by the inertial navigation system, the N first standard deviations with a database, to determine N second standard deviations that are the same as the N first standard deviations;
determining, by the inertial navigation system in the database, a piece of first information corresponding to each of the N second standard deviations, wherein the piece of first information comprises a first probability that the second standard deviation is static, and a weight corresponding to the second standard deviation;
multiplying, by the inertial navigation system, the first probability in each of the N pieces of first information by the corresponding weight, and adding N values obtained through the multiplication, wherein a value obtained through the addition is a second probability that the N first standard deviations are static; and
in response to determining that the second probability is greater than or equal to the static probability threshold, determining that a device in which the inertial navigation system is located is in a static state in the first specified duration.

10. A non-transitory computer-readable medium of claim 9, wherein a correspondence between the second standard deviation and the weight is formed through the following operations:
determining, by the inertial navigation system, a first sample data, measured by the IMU in a second specified duration, of any axis of the N axes, the second specified duration including a plurality of first specified durations;
determining, by the inertial navigation system, a second sample data corresponding to each of a plurality of first specified durations in the second specified duration as static data or dynamic data, a static standard deviation based on the static data, and a dynamic standard deviation based on the dynamic data;
grouping a plurality of determined static standard deviations based on first specified threshold ranges, and determining a quantity of static standard deviations in each of the first specified threshold ranges, to obtain a distribution histogram of the static standard deviations;
grouping a plurality of determined dynamic standard deviations based on second specified threshold ranges, and determining a quantity of dynamic standard deviations in each of the second specified threshold ranges, to obtain a distribution histogram of the dynamic standard deviations;
separately performing a curve fitting operation on the histogram of the static standard deviations and the distribution histogram of the dynamic standard deviations, and normalizing curves obtained through the curve fitting operation, to determine a static standard deviation curve and a dynamic standard deviation curve;
placing the static standard deviation curve and the dynamic standard deviation curve in a same coordinate system, and determining an area of an intersecting part of the static standard deviation curve and the dynamic standard deviation curve; and
determining a reciprocal of the area of the intersecting part as a weight of the plurality of static standard deviations and the plurality of dynamic standard deviations corresponding to any axis of the N axes.

11. A non-transitory computer-readable medium of claim 10, wherein a correspondence between the second standard deviation and the first probability is formed through the following operations:
placing the static standard deviation curve and the dynamic standard deviation curve in a same coordinate system, wherein when the area of the intersecting part of the static standard deviation curve and the dynamic standard deviation curve is determined, each of the static standard deviation curve and the dynamic standard deviation curve has two intersection points with a horizontal axis of the coordinate system, with an intersection point a of the two intersection points having a shorter distance to an origin of the coordinate system than an intersection point b of the two intersection points;
wherein an intersection point of the static standard deviation curve and the dynamic standard deviation curve is an intersection point c;
wherein when the second standard deviation is a value less than or equal to the intersection point a, a probability that the second standard deviation is static is a corresponding probability value of the second standard deviation on the static standard deviation curve;
wherein when the second standard deviation is a value greater than or equal to the intersection point b, a probability that the second standard deviation is static is 0; and
wherein when the second standard deviation is a value greater than the point a and less than the intersection point b, a probability that the second standard deviation is static is: a ratio of the corresponding probability value of the second standard deviation on the static standard deviation curve to a sum of the corresponding probability value of the second standard deviation on the static standard deviation curve and a corresponding probability value of the second standard deviation on the dynamic standard deviation curve.

12. A non-transitory computer-readable medium of claim 9, wherein N is 6.
